(19) United States
(12) Patent Application Publication
(10) Pub. No.: US 2021/0387586 A1
(43) Pub. Date: Dec. 16, 2021

(54) RETRACTABLE AUTOMOTIVE SAFETY DEVICE

(71) Applicant: RideGuard, LLC, Scituate, RI (US)

(72) Inventor: James R. Donnelly-Taylor, Scituate, RI (US)

(21) Appl. No.: 17/231,751

(22) Filed: Apr. 15, 2021

Related U.S. Application Data
(60) Provisional application No. 63/038,417, filed on Jun. 12, 2020.

(51) Int. Cl. B60R 21/06

(52) U.S. Cl. CPC B60R 21/06; B60R 2021/022

(57) ABSTRACT

A retractable automotive safety device includes a primary tube, a secondary bar, and a retractable flexible sheet configured to be drawn from the primary tube to the secondary bar, the retractable clear flexible sheet including a fixed border along an edge of the flexible sheet, the fixed border including a lockable handle configured to fixate to the a secondary bar.

### CROSS REFERENCE TO RELATED APPLICATIONS

This application claims benefit from U.S. Provisional Patent Application Ser. No. 63/038,417, filed Jun. 12, 2020, which is incorporated by reference in its entirety.

### BACKGROUND OF THE INVENTION

The present invention relates generally to protective devices, and more particularly to a retractable automotive safety device.

In general, in certain instances it may be necessary to provide security for a driver of an automobile, such as in a taxi, Uber™, or Lyft™ vehicle. In other instances, it may be necessary to provide a barrier between an automobile driver and one or more passengers to help reduce the chances of transmitting illnesses and diseases, such as viruses and bacteria.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a retractable automotive safety device including a plastic shield, and two longitudinal braces are clasped to the plastic shield, each of the longitudinal braces including a fixation device for secure attachment to a rear of an automotive headrest.

In another aspect, the invention features a retractable automotive safety device including a primary tube, a secondary bar, and a retractable flexible sheet configured to be drawn from the primary tube to the secondary bar, the retractable clear flexible sheet including a fixed border along an edge of the flexible sheet, the fixed border including a lockable handle configured to fixate to the a secondary bar.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 illustrates an exemplary retractable automotive safety device.

FIG. 2 illustrates a cross-section on an attached fixture.

FIG. 3 illustrates exemplary details of an attachment of the secondary bar.

FIG. 4 illustrates an attachment fixture.

FIG. 5 illustrates an adjustment screw.

FIG. 6 illustrates a retractable flexible sheet being drawn out of a primary tube.

FIG. 7 illustrates a flexible sheet withdrawn into the primary tube.

FIG. 8 illustrates a flexible sheet drawn from a primary tube and secured to a secondary bar.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The present invention is a retractable automotive safety device that provides a defensive barrier between drivers and passengers. In addition, the retractable automotive safety device described herein helps drivers to work in a more hygienic environment. More specifically, the retractable automotive safety device of the present invention screens off drivers and passengers from each other, which helps to reduce the chances of transmitting viruses and bacteria by, for example, saliva and direct contact. In addition, the retractable automotive safety device of the present invention provides protection from unwanted “touching” by a rear seat occupant upon a driver and/or occupant in a front seat. Moreover, the retractable automotive safety device of the present invention is flexible in that it can be adapted to all sizes of vehicles.

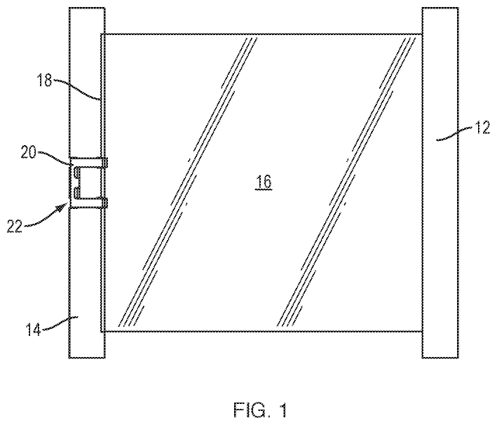

As shown in FIG. 1 an exemplary retractable automotive safety device 10 includes a primary tube 12 and a secondary bar 14. A retractable generally clear flexible sheet 16 is stretched from the primary tube 12 and the secondary bar 14. The retractable clear flexible sheet 16 includes a fixed border 18 along an edge of the flexible sheet 16. The fixed border 18 includes a lockable handle 20. The lockable handle 20 is designed to engage a notch 22 in the secondary bar 14 which secures the handle 20 to the secondary bar 14.

The primary tube 12 includes a mechanism that enables the flexible sheet 16 to be stored within (i.e., retracted into) the primary tube 12 when not engaged to the secondary bar 14 and retracted from the primary tube 12 to be engaged with the secondary bar 14. More specifically, when the flexible sheet 16 is retracted into the primary tube 12, the lockable handle 20 is used to draw the flexible sheet 16 out of the primary tube 12 and across to the secondary bar 14 where the lockable handle 20 can be removably engaged to the secondary bar 14. Once engaged, the flexible sheet 16 provides a barrier between front and rear occupants of a vehicle.

In embodiments, the lockable handle 20 includes an additional locking component, such as a cotter pin, to insure against accidental unlocking.

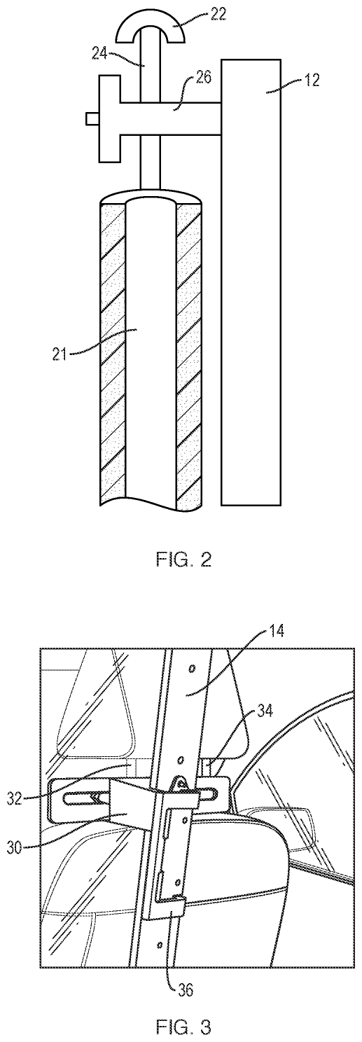

Both the primary tube 12 and the secondary bar 14 are removably secured to headrest posts of opposite vehicle seats by an attachment fixture. For example, as shown in cross section in FIG. 2, an exemplary vehicle seat 21 includes a headrest 22. The headrest 22 is fixed to a headrest pole 24. The headrest 22 can be moved about the headrest pole relative to the vehicle seat 21. The primary tube 12 (of FIG. 1) includes an attachment fixture 26. The attachment fixture 26 extends from the primary tube 12 and is designed to lock on to the headrest pole 24. When the attachment fixture 26 is locked onto the headrest pole 24 the primary tube 12 is fixed in position relative to a back of the vehicle seat 21.

In FIG. 3, exemplary details of an attachment of the secondary bar 14 are illustrated. A front side of the secondary bar 14 includes an attachment fixture 30 that secures the secondary bar 14 to two headrest poles 32, 34. On a back side of the secondary bar 14 a handle 36 is attached to a flexible sheet 36 is shown fixed to the secondary bar 14.

As shown in FIG. 4, in one embodiment, an attachment fixture 40 includes a clip 42 and a adjustable screw 44. The clip 42 is designed to engage a first headrest pole 46 while the adjustable screw 44 is designed to engage a second headrest pole 48. When both the clip 42 and the adjustable screw 44 are engaged to the first and second headrest poles 46, 48, a corresponding primary tube 50 (or secondary bar (not shown)) is secured to a backside of a vehicle seat 52.

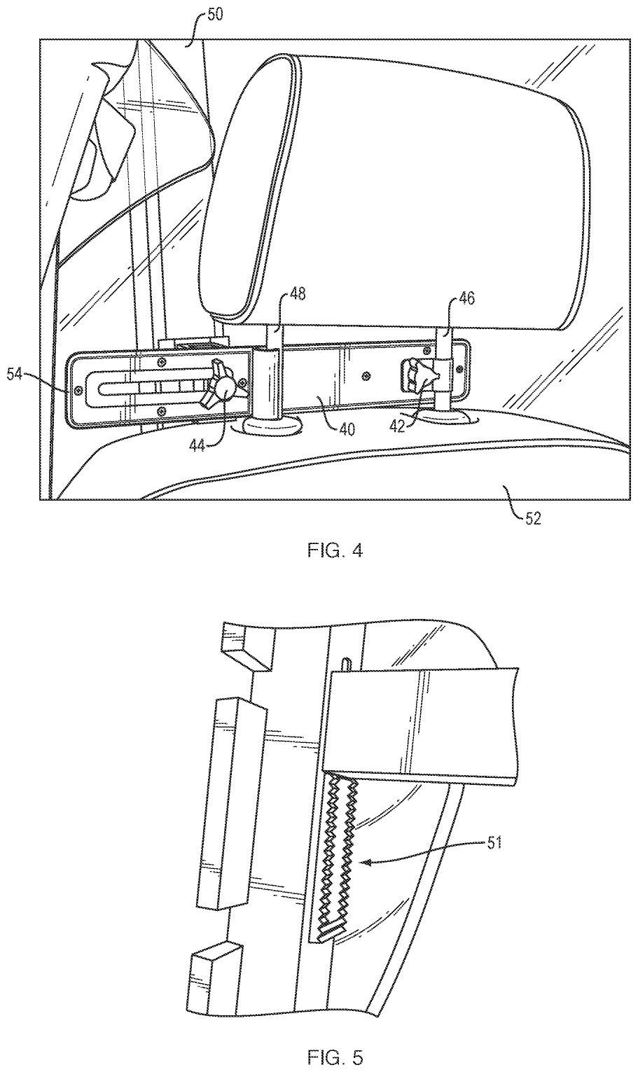

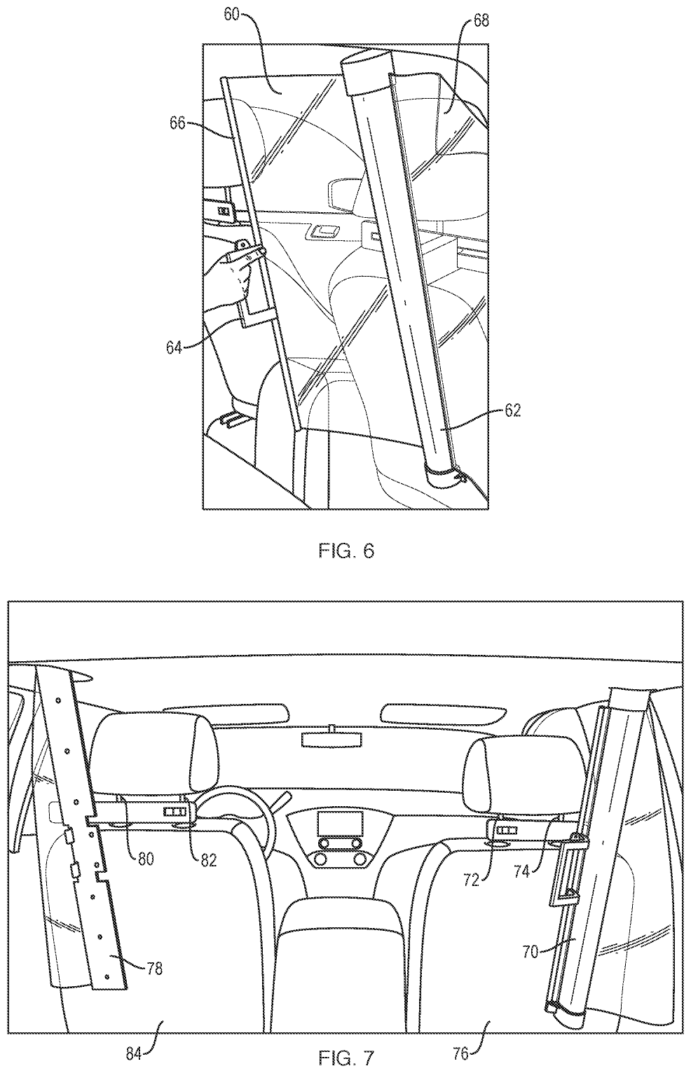

The adjustment screw 44 also serves an additional function. As shown in FIG. 5, both the primary tube and the secondary bar include a serrated section 51. The adjustment screw 44 enables the primary tube and the secondary bar to be secured upon various lateral positions of the serrated section 51. This feature enables the primary tube and the secondary bar to fit within a variety of vehicle sizes.

In FIG. 6, a retractable flexible sheet 60 is shown being drawn out of a primary tube 62. Here, a handle 64 is shown attached to a solid border 66 on the flexible sheet 60 to enable a user to draw the flexible sheet 60 out (and to allow the flexible sheet 60 to be drawn back into the primary tube 62 when not in use).

In FIG. 7, a primary tube 70 linked to headrest posts 72, 74 of a first vehicle seat 76 and a secondary bar 78 linked to headrest posts 80, 82 of a second vehicle seat 84 are illustrated. In the configuration shown, a flexible sheet is withdrawn into the primary tube 70.

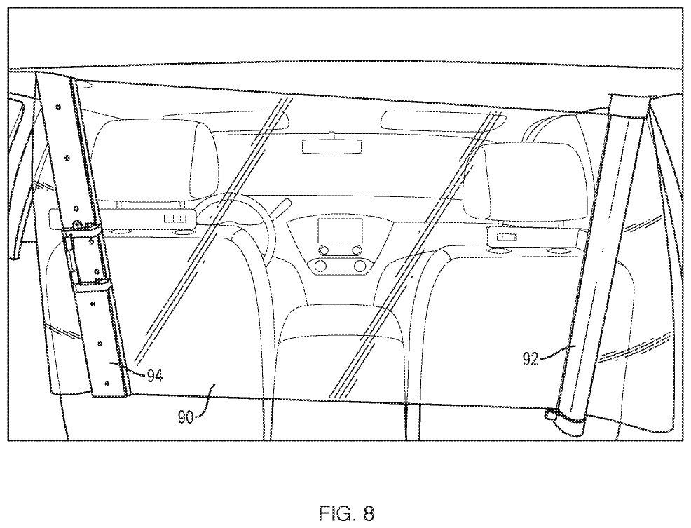

In FIG. 8, a flexible sheet 80 is shown drawn from a primary tube 82 and secured to a secondary bar 84.

Although the flexible sheet described above is preferably clear, other embodiments include tinted flexible sheets.

In a preferred embodiment, the flexible sheet is a marine grade vinyl sheet. And in a preferred embodiment, the marine grade vinyl sheet has a thickness of 18-20 gauge.

The flexible sheet enables the retractable automotive safety device to be used when opposite seats in a vehicle are not perfectly aligned with each other, as often is the case in the real world.

Referring again to FIG. 6, each of the primary tube and the secondary bar may include a fixed clear plastic flexible end wing 68 attached outwardly to provide addition protection. These flexible end wings 68 may be adjusted to further provide a barrier between occupants in the back seat and occupants in the front seat.

The retractable automotive safety device is designed and built to provide a durable, flexible and easy way to help shield drivers and passengers.

The retractable automotive safety device can provide surface coverage between drivers and passengers, i.e., the retractable automotive safety device covers a majority of the usual contact points between drivers and passengers and therefore helps to improve hygiene.

The retractable automotive safety device is easy to clean.

The foregoing description of the preferred embodiments of the invention is by way of example only, and other variations of the above-described embodiments and methods are provided by the present invention. The embodiments described herein have been presented for purposes of illustration and are not intended to be exhaustive or limiting. Many variations and modifications are possible in light of the foregoing teaching. The invention is limited only by the following claims.

What is claimed is:

1. A retractable automotive safety device comprising:
a plastic shield; and
two longitudinal braces are clasped to the plastic shield, each of the longitudinal braces including a fixation device for secure attachment to a rear of an automotive headrest.

2. The retractable automotive safety device of claim 1 wherein each fixation device is configured to slide within its respective longitudinal device to enable variable positioning of the fixation device with respect to the automotive headrest.

3. The retractable automotive safety device of claim 2 wherein the plastic shield is clear.

4. The retractable automotive safety device of claim 2 wherein the plastic shield is tinted.

5. The retractable automotive safety device of claim 1 wherein the plastic shield is constructed from a rigid polycarbonate.

6. The retractable automotive safety device of claim 5 wherein the rigid polycarbonate is 1.5 mm in thickness.

7. A retractable automotive safety device comprises:
a primary tube;
a secondary bar; and
a retractable flexible sheet configured to be drawn from the primary tube to the secondary bar, the retractable clear flexible sheet comprising a fixed border along an edge of the flexible sheet, the fixed border including a lockable handle configured to fixate to the a secondary bar.

8. The retractable automotive safety device of claim 7 wherein the lockable handle engages a notch in the secondary bar which secures the handle to the secondary bar.

9. The retractable automotive safety device of claim 8 wherein the lockable handle includes an additional locking component to insure against accidental unlocking.

10. The retractable automotive safety device of claim 9 wherein the additional component is a cotter pin.

11. The retractable automotive safety device of claim 8 wherein the primary tube includes a mechanism that enables the flexible sheet to be retracted into the primary tube when not engaged to the secondary bar and retracted from the primary tube to be engaged with the secondary bar.

12. The retractable automotive safety device of claim 11 wherein the primary tube and the secondary bar each include an attachment fixture to secure them to vehicle headrest posts.

13. The retractable automotive safety device of claim 12 wherein an attachment fixture includes a clip and a adjustable screw.

14. The retractable automotive safety device of claim 13 wherein the clip is designed to engage a first headrest pole while the adjustable screw is designed to engage a second headrest pole 48.

15. The retractable automotive safety device of claim 14 the adjustment screw enables the primary tube and the secondary bar to be secured upon various lateral positions of a serrated section.

16. The retractable automotive safety device of claim 7 further comprising formed flexible wing sheets extending outwardly from the primary tube and the secondary bar.
